(19) United States
(12) Patent Application Publication
(10) Pub. No.: US 2024/0181544 A1
(43) Pub. Date: Jun. 6, 2024

(54) PIVOTABLE LOG SAW FOR MAINTENANCE IMPROVEMENT

(71) Applicant: Carbotech International, Plessisville (CA)

(72) Inventors: Jacques Lajoie, Levis (CA); Thomas Lajoie, Levis (CA)

(21) Appl. No.: 18/519,896

(22) Filed: Nov. 27, 2023

Related U.S. Application Data
(60) Provisional application No. 63/429,674, filed on Dec. 2, 2022.

(51) Int. Cl. B23D 45/04; B23D 47/12

(52) U.S. Cl. CPC B23D 45/046; B23D 47/123

(57) ABSTRACT

A pivotable log saw is movable between an operating position and a maintenance position. The saw includes: a housing; a turntable pivotably mounted to the housing to rotate around an axis; a saw arm pivotably mounted to the turntable to rotate around another axis; an arm-driving motor mounted to the turntable, the arm-driving motor being connected to the saw arm and controlling slope of the saw arm; a blade-driving motor mounted to the saw arm, a saw blade mounted to the saw arm, and connection between the blade-driving motor and the saw blade wherethrough the blade-driving motor drives rotation of the saw blade; and a locking mechanism adapted, in a locked position, to lock the turntable in the operating position, and, in an unlocked position, allows the turntable to rotate in a maintenance position.

### CROSS-REFERENCE TO RELATED APPLICATION

This application relates to and is a non-provisional application claiming priority under 35 U.S.C. § 119(e) from U.S. provisional patent application No. 63/429,674, filed Dec. 2, 2022, entitled PIVOTABLE LOG SAW FOR MAINTENANCE IMPROVEMENT, the specification of which is hereby incorporated herein by reference in its entirety.

### BACKGROUND

### (a) Field

The subject matter disclosed generally relates to sawmill equipment. More particularly, the subject matter disclosed relates to saws.

### (b) Related Prior Art

Industrial saws for sawmills are currently hard to maintain. Operators must step over other equipment, bringing the operator into unsecured situations to provide maintenance over saws.

There is therefore a need for development improving the security of operators when performing maintenance of the saws in sawmills. It is further a need for development in easing the process of maintenance of the saws.

### SUMMARY

In some aspects, the techniques described herein relate to a pivotable log saw movable between an operating configuration and a maintenance configuration, the pivotable log saw including: a housing; a turntable rotatably or pivotably mounted to the housing around a first axis; a saw arm pivotably mounted to the turntable around a second axis; an arm-driving motor mounted to the turntable connected to the saw arm and driving slope of the saw arm; a blade-driving motor mounted to the saw arm, a saw blade mounted to the saw arm, and a connection between the blade driving motor and the saw blade wherethrough the blade-driving motor drives the saw blade; and a locking mechanism adapted, in a locked position, to lock the turntable in the operating configuration, and, in an unlocked position, the turntable be able to rotate between an operating position and a maintenance position wherein the saw arm extends at an angle different from 0 degree relative to the operating position. Hereinafter, the term pivotably is going to be used without disclaiming the term rotatably.

In some aspects, the techniques described herein relate to a pivotable log saw mounted to and mobile over a bridge, the pivotable log saw movable between an operating configuration and a maintenance configuration, the pivotable log saw including: a housing; a traveling motor housed in the housing; a pivotably piece connected to the travelling motor, the pivotably piece abutting the bridge and pivotably driven by the traveling motor to move the pivotable log saw relative to the bridge; a turntable pivotably mounted to the housing around a first axis; a saw arm pivotably mounted to the turntable around a second axis; an arm-driving motor mounted to the turntable, the arm-driving motor being connected to the saw arm and controlling slope of the saw arm; a blade-driving motor mounted to the saw arm, a saw blade mounted to the saw arm, and connection between the blade-driving motor and the saw blade whereby the blade-driving motor drives the saw blade; and a locking mechanism adapted, in a locked position, to lock the turntable in the operating configuration, and, in an unlocked position, allows turning the turntable thereby have the saw arm extends in an angle different from 0 degree relative to its extending direction in the operating configuration.

In some aspects, the techniques described herein relate to a pivotable log saw movable between an operating position and a maintenance position, the pivotable log saw including: a frame; a turntable pivotably mounted to the frame around a first axis; a motorized saw arm mounted to the turntable movable between an idle position and a cutting position; a motorized saw blade mounted to the saw arm; and a releasable locking mechanism that, when locked, locks the turntable in the operating position, and, when unlocked, allows rotation of the turntable over at least 30 degree around the first axis to adopt the maintenance position.

In some aspects, the techniques described herein relate to a pivotable log saw, wherein the motorized saw arm is pivoting mounted to the turntable.

In some aspects, the techniques described herein relate to a pivotable log saw, wherein a first motor mounted to the turntable motorizing the saw arm.

In some aspects, the techniques described herein relate to a pivotable log saw, wherein an articulated arm couples the first motor to the saw arm.

In some aspects, the techniques described herein relate to a pivotable log saw, wherein a second motor mounted to the saw arm motorizes the saw blade.

In some aspects, the techniques described herein relate to a pivotable log saw, including a pivot on which the saw arm is mounted, with the saw blade mounted to the saw arm distant to the pivot in a first direction and a motor driving the saw blade mounted to the saw arm distant to the pivot in a second direction opposed to the first direction.

In some aspects, the techniques described herein relate to a pivotable log saw, further including a roller assembly coupled to the frame, with the pivotable log saw designed to be slidingly mounted to a bridge through the roller assembly.

In some aspects, the techniques described herein relate to a pivotable log saw, further including a gear interfacing with a gear-racked beam of the bridge.

In some aspects, the techniques described herein relate to a pivotable log saw, further including a motor driving the gear, thereby driving longitudinal displacement of the pivotable log saw along the bridge.

In some aspects, the techniques described herein relate to a pivotable log saw, wherein the locking mechanism including a first opening in the turntable and a second opening in the frame that can be aligned with each other, and a key insertable into the first opening and the second opening when aligned.

In some aspects, the techniques described herein relate to a pivotable log saw, further including a lever mechanism operable to move the key between an engaged position in which the key is inserted in the first opening and the second opening, and a cleared position wherein the key is removed from at least one of the first opening and the second opening.

In some aspects, the techniques described herein relate to a pivotable log saw, further including a third opening aligned with one of the first opening and the second opening when the turntable in the maintenance position.

In some aspects, the techniques described herein relate to a pivotable log saw, further including a wedge-locking mechanism designed to lock the turntable.

In some aspects, the techniques described herein relate to a pivotable log saw, wherein the wedge-locking mechanism includes a combination of wedging disks mounted to a shaft to which is mounted the turntable.

In some aspects, the techniques described herein relate to a pivotable log saw, wherein the wedging disks including complementary sloped faces facing each other, wherein the combination of wedging disks are designed to expend axially upon relative rotation of a first wedging disk relative to the other one of the wedging disks.

In some aspects, the techniques described herein relate to a pivotable log saw, wherein the sloped faces include a plurality of segmented sloped portions.

In some aspects, the techniques described herein relate to a pivotable log saw, further including an actuator and arm assembly coupled to one of the wedging disks.

In some aspects, the techniques described herein relate to a pivotable log saw, wherein the actuator is an electric jack.

In some aspects, the techniques described herein relate to a pivotable log saw, further including securing component mounted to the shaft of the turntable, the securing component limiting axial displacement of a sprocket mounted to the shaft away from the frame, defining a maximum length over the shaft for the sprocket and the wedging disks.

In some aspects, the techniques described herein relate to a pivotable log saw, further including a motor driving a motorized shaft on which is mounted the turntable.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a perspective elevation view of a pivotable log saw mounted to a bridge, wherein the pivotable log saw is in a maintenance configuration with an operator standing on the bridge beside the pivotable log saw, in accordance with an embodiment;

FIG. 2 is a plan view of the pivotable log saw, the bridge, and the operator of FIG. 1;

FIG. 3 is a perspective elevation view of a pivotable log saw mounted to a bridge, wherein the pivotable log saw is in an operating configuration;

FIG. 4 is a rear elevation view of the pivotable log saw mounted to the bridge consistent with FIG. 3;

FIG. 5 is a front elevation view of the pivotable log saw mounted to the bridge consistent with FIG. 3;

FIG. 6 is a left-side elevation view of the pivotable log saw mounted to the bridge consistent with FIG. 3;

FIG. 7 is a close-up rear-bottom perspective view of the pivotable log saw mounted to the bridge in accordance with an embodiment;

FIG. 8 is a closer close-up rear-bottom perspective view of the pivotable log saw mounted to the bridge consistent with FIG. 7;

FIG. 9 is a perspective elevation view of the pivotable log saw of FIG. 3;

FIG. 10 is a perspective bottom view of the pivotable log saw of FIG. 3;

FIG. 11 is a left-side elevation view of the pivotable log saw depicted on FIG. 3;

FIG. 12 is a rear elevation view of the pivotable log saw depicted on FIG. 3;

FIG. 13 is a cross-section perspective elevation view of the pivotable log saw depicted on FIG. 12 according to cross-section line 13-13 depicted on FIG. 9;

FIG. 14 is a close-up plan view of the upper module section turning mechanism and the wedge-locking mechanism in accordance with an embodiment;

FIG. 15 is a side elevation view of the upper module section turning mechanism and the wedge turning mechanism consistent with FIG. 14;

FIG. 16 is a perspective view of a locking key and lever mechanism in accordance with an embodiment;

FIG. 17 is close-up cross-section perspective view of a portion of the pivotable log saw in accordance with an embodiment;

FIG. 18 is a side view of the slope locking mechanism in accordance with an embodiment;

FIG. 19 close-up cross-section elevation view of the locking interface of the slope locking mechanism of FIG. 18;

FIG. 20 is an elevated side view of the pivotable log saw with the saw blade in a raised position;

FIG. 21 is an elevated side view of the pivotable log saw with the saw arm slightly moved from the raised position depicted on FIG. 20 toward a lowered position;

FIG. 22. Is an elevated side view of the pivotable log saw with the saw arm moved to the lowered position;

FIG. 23 is a perspective partial view of the pivotable log saw with the saw arm extending in the operating position and the lever mechanism in the locking position; and

FIG. 24 is a perspective partial view of the pivotable log saw depicted on FIG. 23 with the saw arm extending in the operating position and the lever mechanism in the unlocked position.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as,” or the like) provided herein, is intended merely to better illuminate the exemplary realizations and does not pose a limitation on the scope of the realizations. No language in the specification should be construed as indicating any unclaimed element as essential to the practice of the realizations.

In the following description, it is understood that terms such as “first”, “second”, “top”, “bottom”, “above”, “below”, and the like, are words of convenience and are not to be construed as limiting terms unless explicitly stated otherwise.

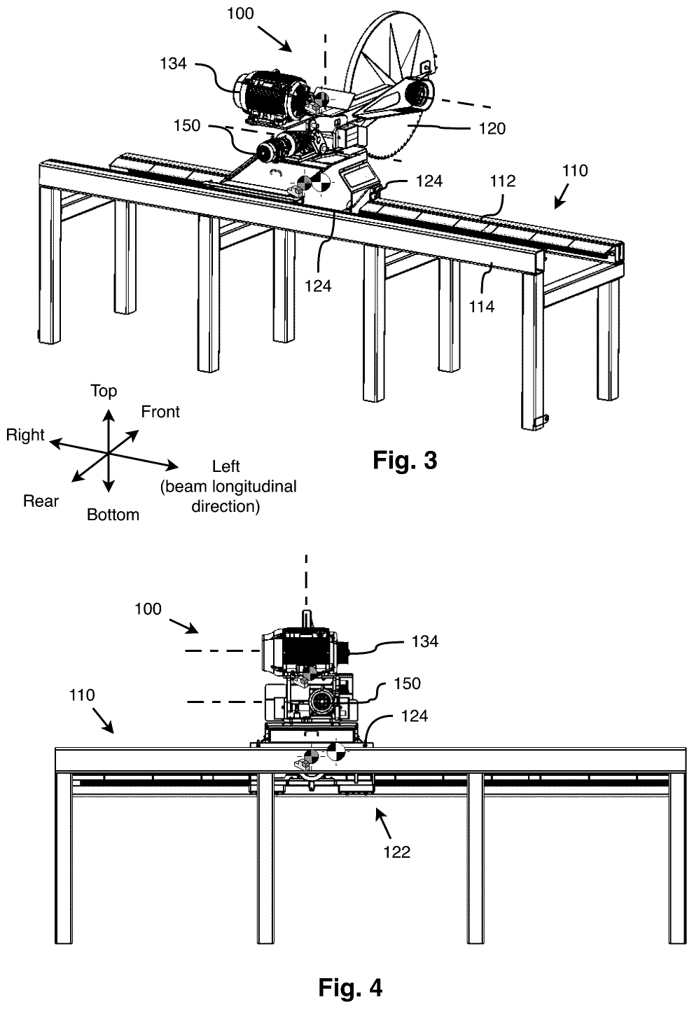

The terms “top”, “up”, “upper”, “bottom”, “lower”, “down”, “vertical”, “horizontal”, “interior” and “exterior” and the like are intended to be construed in their normal meaning in relation with normal installation of the product, with indication of normal orientation of the components being provided on FIG. 3.

It should further be noted that for purposes of this disclosure, the term “coupled” means the joining of two members directly or indirectly to one another. Such joining may be stationary or movable in nature. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

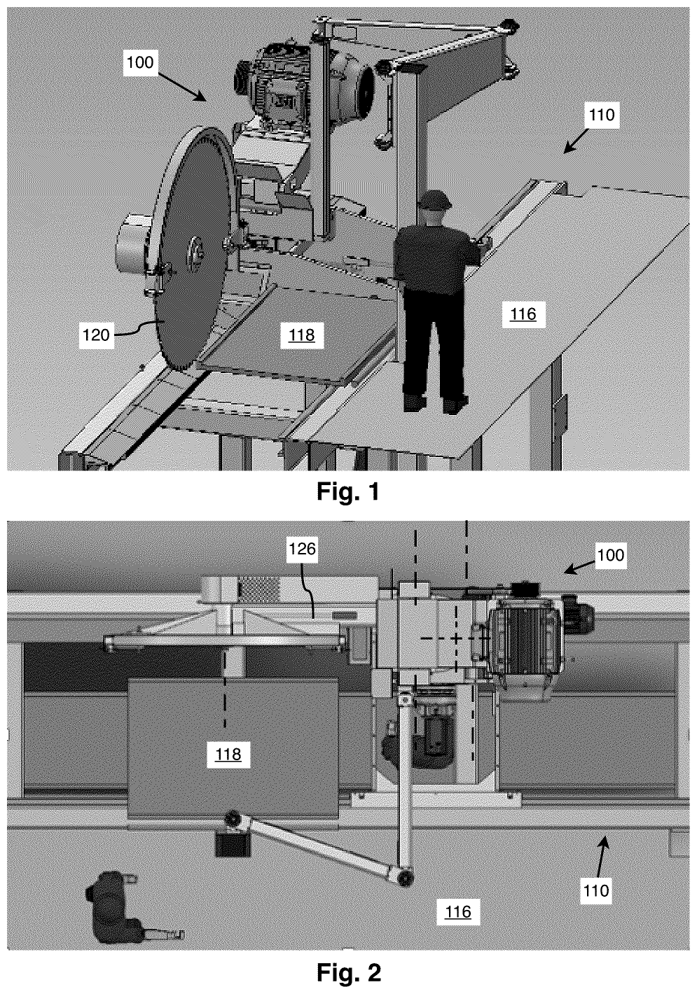

Referring now to the drawings, and more particularly to FIGS. 1 and 2, a pivotable log saw 100 mounted to a bridge 110 with the saw blade 120 rotated from the operating position (depicted e.g., in FIG. 3) into a maintenance position (depicted e.g., in FIGS. 1 and 2) resulting from a rotation of at least 30 degrees rotation, and preferably of about 90 degrees of the top portion of the pivotable log saw 100.

Referring additionally to FIG. 3, the bridge 110 consists in a scaffold structure having a front in which direction the saw blade 120 extends in an operating position, comprising at its top a front beam 112 frontward to a rear beam 114. For maintenance, floor portions 116, 118 may be installed on the beam 114 for an operator to perform maintenance, e.g., change saw blade 120, in a secure manner instead of over the log conveyor (not depicted) with log saws of the PRIOR ART.

In the operating condition, a log conveyor (not depicted) is mounted in front of the bridge 110, with the logs or pieces of wood travelling substantially horizontally and parallel to the longitudinal direction of the beams 112, 114 of the bridge 110, and thus transversally to the plane of the saw blade 120 in the operating position.

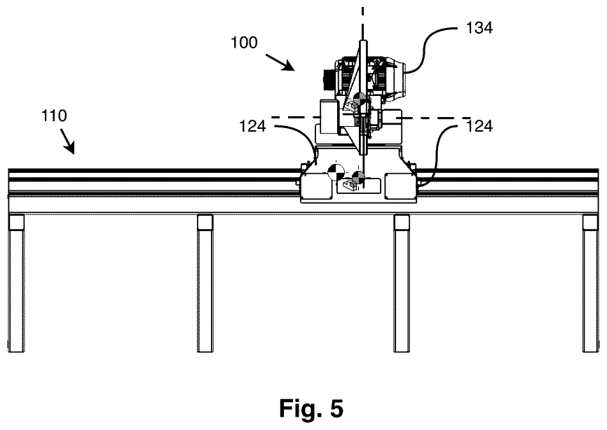

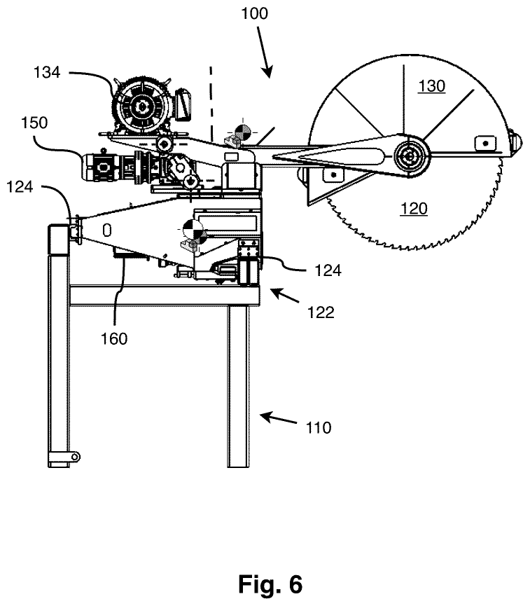

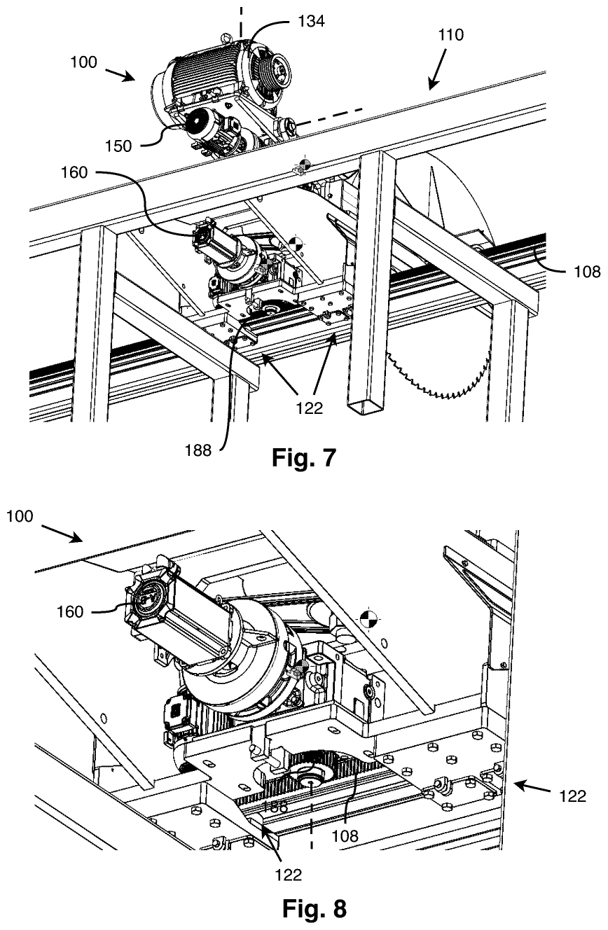

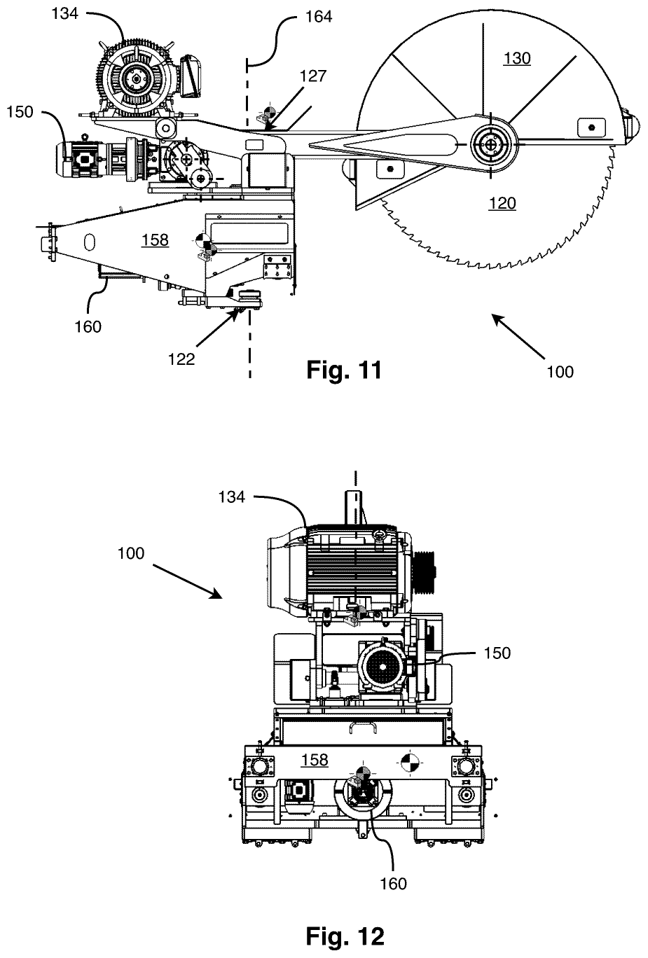

Referring to FIGS. 3 to 6, the pivotal log saw 100 is mountable to the bridge 110, dismountable and mobile over a range of positions over the bridge 110. The pivotable log saw 100 comprises a roller assembly 122, depicted on FIG. 11, set into a C-channel gear-racked beam 108 manufactured by welding a rack gear to a C-channel beam, see FIGS. 7 and 8, wherein the C-channel gear-racked beam 108 is located at the front for guidance. Cam followers 124 are at the front and the rear for mounting the pivotal log saw 100 to the beams 112, 114 therethrough for the pivotable log saw 100 to be able to be moved in the longitudinal direction of the beams 112, 114 of the bridge 110.

Referring to FIGS. 7 and 8, an interface between the C-channel gear-racked beam 108 located aside the front beam 112 is adapted fora gear 188 driven by the motor 160, see FIG. 10, to allow the pivotable log saw 100 to autonomously adjust its left/right position along the beams 112, 114.

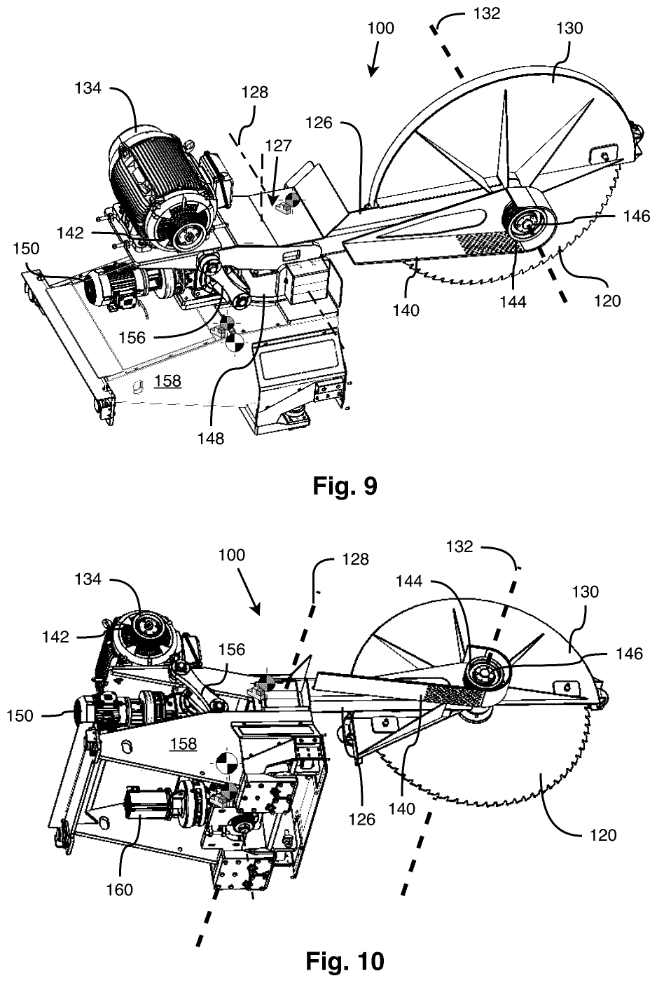

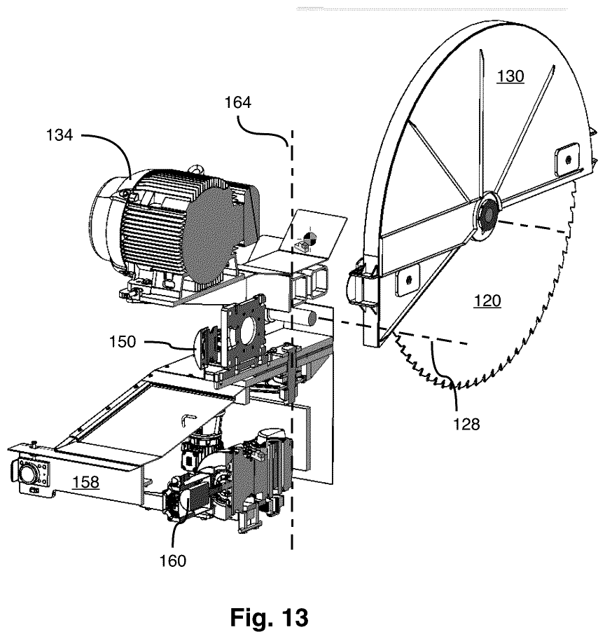

Referring to FIGS. 9 to 13, a housing 158, or more generally a frame 158, houses a motor 160 dedicated to drive longitudinal displacements of the pivotable log saw 100. Interface between the C-channel gear-racked beam 108 and the gear 188 connected to the motor 160, when the motor 160 drives the gear 188 clockwise or counterclockwise, forces displacement of the gear 188 parallel to the C-channel gear-racked beam 108, and thus displacement of the pivotable log saw 100.

The pivotable log saw 100 comprises a saw blade 120 extending at the front end of a saw arm 126, with the saw blade 120, driven by the blade-driving motor 134, adapted to pivot around a blade axis 132, and the saw arm 126, driven by the motor 150, to rotate around a pivot 127 defining the arm axis 128 around which moves vertically the saw blade 120 between a low, cutting position, and a raised position, more generally called an idle position. A shield 130 covers the top portion of the saw blade 120.

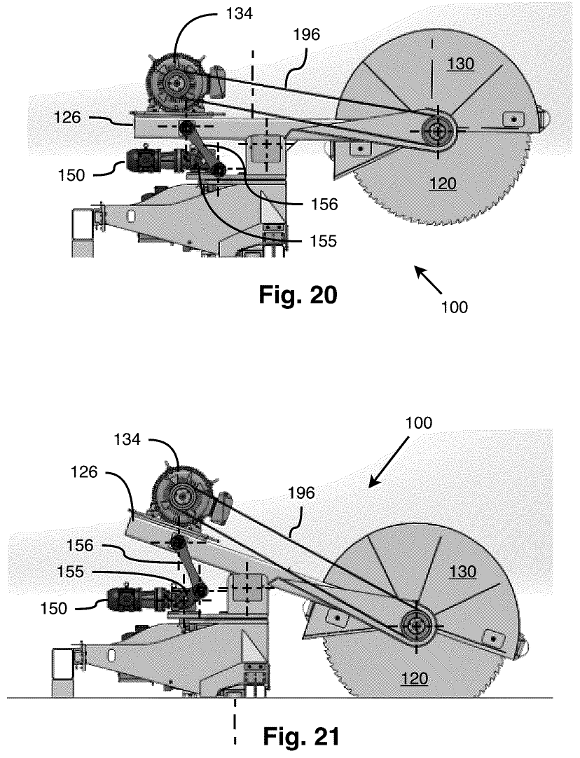

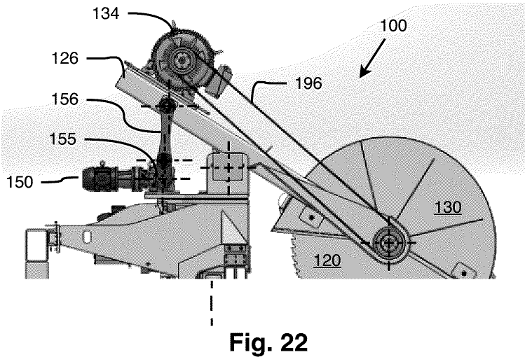

FIG. 20 depicts the saw blade 120 in its fully raised position. FIG. 21 depicts the saw blade 120 slightly lowered from the raised position with an articulated arm comprising the arms 155, 156 driven by the motor 150 and raising the rear portion of the saw arm 126, rotating the saw arm 126 around the axis 128 and thereby lowering the front of the saw arm 126 and the saw blade 120 closer to the conveyor. FIG. 22 depicts the motor 150 having rotated the arm 155 so that the arms 155, 156 are aligned with each other, raising the rear of the saw arm 126 to its maximum, thereby lowering the saw blade 120 to its minimum height into the cutting position with the front portion of the saw arm 126 at the closest to the conveyor.

It is worth mentioning that the pivotable log saw 100 is designed such that the saw arm 126 extends to the front to the saw blade 120 and to the rear beyond the arm axis 128, wherein the blade-driving motor 134 is mounted to the saw arm 126, providing a counterweight to the saw blade 120 over the saw arm 126. Pulleys 142, 144 are mounted to the blade-driving motor 134 and to a blade shaft 146 on which is mount the saw blade 120. A belt 196 connects the blade-driving motor 134 to the blade shaft 146, driving the saw blade 120. A guard 140 surrounds partially the pulley 142 and extends rearward toward the blade-driving motor 134 below the belt to avoid saw dust to and debris to hit the belt.

It is further worth mentioning that through the present description is contemplated different idle position and associated movement to travel from one to the other, including described rotation and translation of the saw arm frontward/rearward.

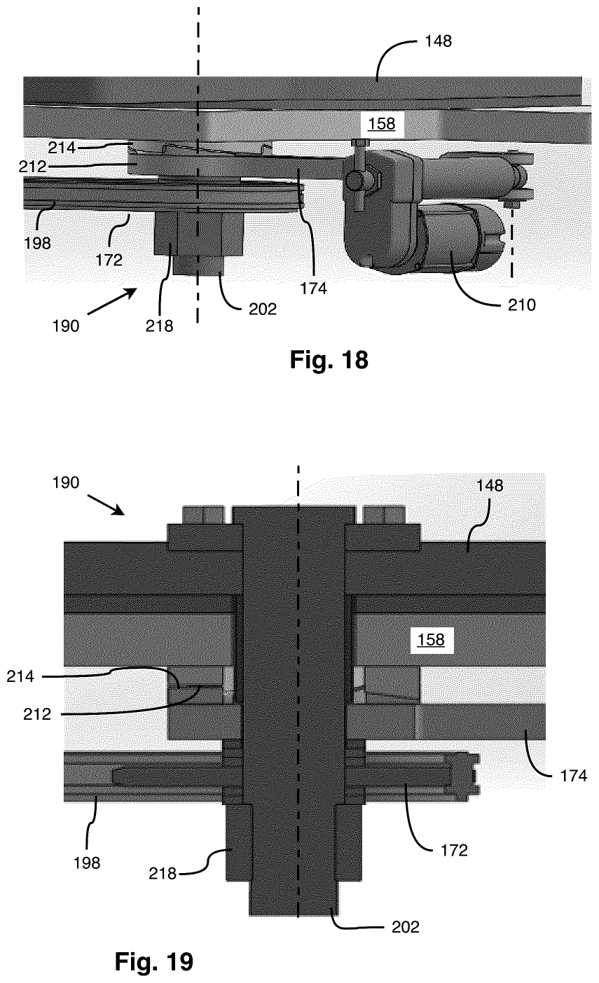

Referring now to FIGS. 9-15 and 18-19, the pivotable log saw 100 comprises a saw rotating mechanism 170 able to rotate the turntable 148 around turntable axis 164 and components mounted thereto between an operating position wherein the saw arm 126 extends perpendicular to the beams 112, 114, depicted on FIG. 3, and a maintenance position wherein the saw arm 126 is perpendicular to the operating position, depicted on FIG. 1. A gearmotor 200 is connected to a turntable shaft 202 which is mounted to the turntable 148. A sprocket 172 is mounted to the turntable shaft 202, adapted to drive the turntable shaft 202. A chain 198 connects the gearmotor 200 to the sprocket 172.

A releasable locking mechanism allows to lock/unlock the turntable so that the turntable may take the operating position or the maintenance position.

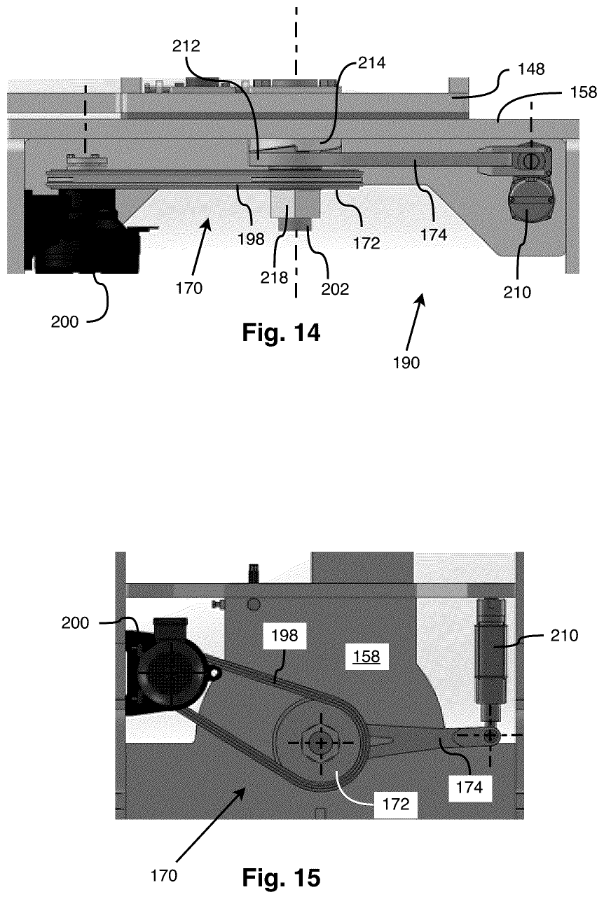

Concerning the releasable locking mechanism, when a first (manual) locking component locking the turntable 148 is unlocked and a second (motorized) locking component comprising an actuator, e.g., an electric jack 210, does not exert external force on the shaft mounted sprocket 172, e.g., through an arm 174, the gearmotor 200 is adapted to drive the turntable 148 in one direction or the other until the rotation of the turntable 148 results in the saw arm 126 adopting one of the operating position and the maintenance position. Once in the desired position, two solutions are used to lock the turntable 148 in position. A first, automated solution depicted on FIGS. 14 and 15, consists in a wedge-locking mechanism 190 that compresses the turntable 148 to the plate of the housing 158, depicted on FIG. 14. The compression force exerted by the 2 wedging disks 212, 214 over the plate of the housing 158 and the sprocket 172 of e.g., around 30 000 pounds-force, prevents the turntable to rotate (through normal force and friction exerted thereto). An important role performed by the wedge-locking mechanism 190 consists in stabilizing the upper section during operation by “sticking” it, aka compressing it without any relative sliding being possible, to the saw module. Therefore, when the operator wants to turn the upper section, he needs to remove this compression force by unengaging the wedge-locking mechanism 190, allowing the turntable 148 to move freely. It is to be noted that compression is exerted and removed though operation of an electric jack 210 that exerts force through the arm 174, resulting in an outward force away from the turntable 148.

For illustration, the wedging disks 212, 214 are disks mounted to the turntable shaft 202, having a flat side and on the other side a sloped face. The slopes faces features a plurality of sloped portion that are complementary between the other one of the wedge disks, and are facing each other. Relative rotation of one wedging disk 212 relative to the other wedge disk 214 (e.g., mounted to the frame) results in the combination of wedge disks expending axially, generating pressure over the frame 158 and the sprocket 172 hindered from axial displacement by the securing component 218. Preferably, a plurality of, e.g., 4, segmented sloped portions define a sloped face.

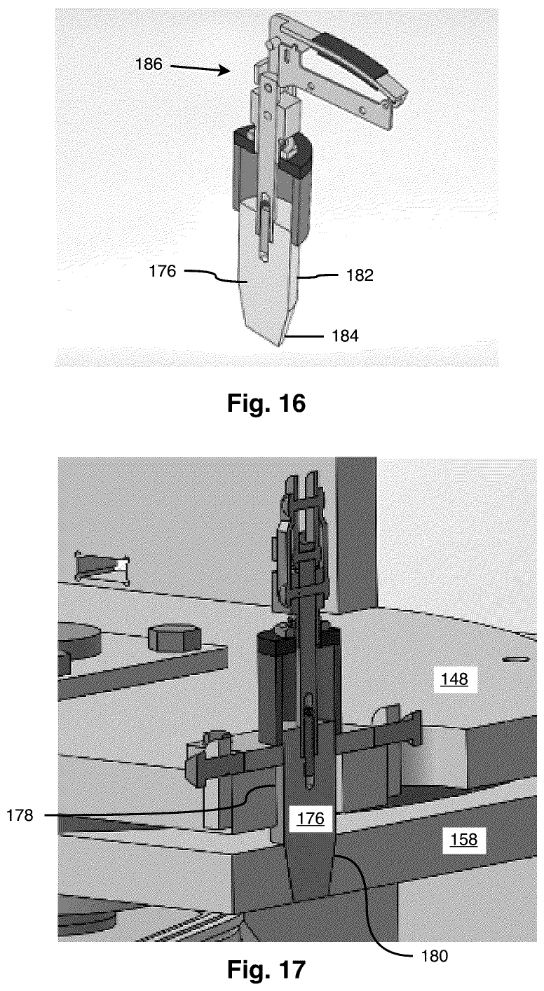

Referring to e.g., FIGS. 1 and 3, and FIGS. 16 and 17, a manual locking mechanism, specifically a lever mechanism 186, is further used to lock the pivotable log saw 100 in the operating position. The manually operated lever mechanism 186 provides a stable structure in this configuration. In the operating position, logs are travelling perpendicular to the arm saw arm 126. The pivotable log saw 100 must be able to resist to variable forces parallel to the axis 132 in case the conveyor and the pivotable log saw 100 are not fully synchronized or in case inertia of the logs generates transversal forces to the saw blade 120. Accordingly, the lever mechanism 186 features a key 176 insertable and removable from aligned openings 178, 180 present in the turntable 148 and in the housing 158, thereby movable between an engaged position and a cleared position.

It is worth mentioning that in an alternative realization two openings 180 may be present in the housing; a first one where the turntable opening 178 and the first housing opening 180 are aligned when the turntable 148 is in the operating position, and a second one where the turntable opening 178 and the second housing opening 180 are aligned when the turntable 148 is in the maintenance position.

In a preferred embodiment, the key 176 features a cylindrical portion 182 and a frustoconical portion 184 adapted to be inserted in a frustoconical opening 180 located in the housing 158 though the turntable opening 178 located in the turntable 148. The lever mechanism 186 allows to manually insert and/or dislodge the frustoconical portion 184 of the key 176 from the frustoconical opening 180 present in the housing 158 to change configuration of the pivotable log saw 100.

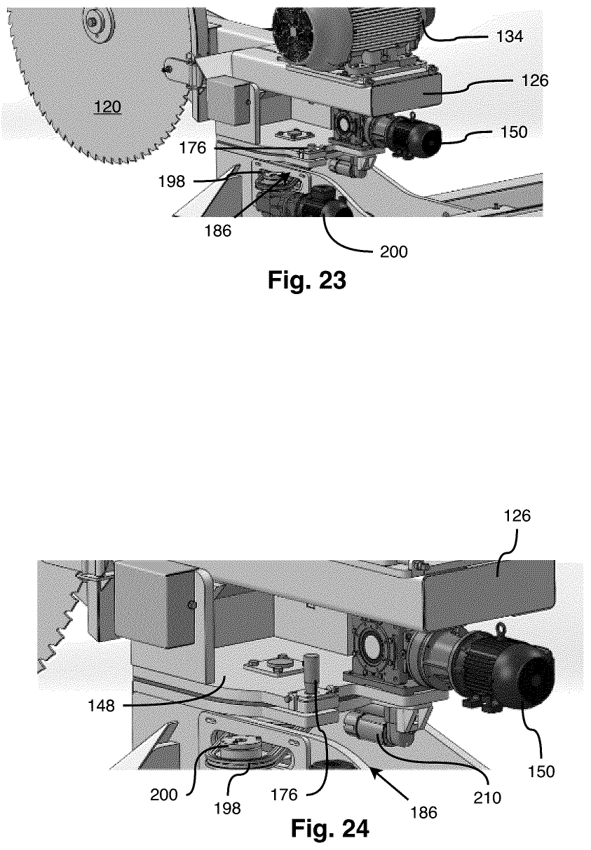

Referring to FIGS. 23 and 24, the saw arm 126 is on FIG. 23 in an operative position with the key 176 inserted in the openings 178, 180. FIG. 24 depicts the key 176 being raised out of the opening 180, partially raised outside the turntable opening 178. When the key 176 is raised, the gearmotor 200 may drive the chain 198, which results in rotation of the turntable 148 on which is mounted the saw arm 126 and the saw blade 120.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A pivotable log saw movable between an operating position and a maintenance position, the pivotable log saw comprising:
a frame;
a turntable pivotably mounted to the frame around a first axis;
a motorized saw arm mounted to the turntable movable between an idle position and a cutting position;
a motorized saw blade mounted to the saw arm; and
a releasable locking mechanism that, when locked, locks the turntable in the operating position, and, when unlocked, allows rotation of the turntable over at least 30 degree around the first axis to adopt the maintenance position.

2. The pivotable log saw of claim 1, wherein the motorized saw arm is pivoting mounted to the turntable.

3. The pivotable log saw of claim 1, wherein a first motor mounted to the turntable motorizing the saw arm.

4. The pivotable log saw of claim 3, wherein an articulated arm couples the first motor to the saw arm.

5. The pivotable log saw of claim 1, wherein a second motor mounted to the saw arm motorizes the saw blade.

6. The pivotable log saw of claim 5, comprising a pivot on which the saw arm is mounted, with the saw blade mounted to the saw arm distant to the pivot in a first direction and blade-driving motor driving the saw blade mounted to the saw arm distant to the pivot in a second direction opposed to the first direction.

7. The pivotable log saw of claim 1, further comprising a roller assembly coupled to the frame, with the pivotable log saw designed to be slidingly mounted to a bridge through the roller assembly.

8. The pivotable log saw of claim 7, further comprising a gear interfacing with a gear-racked beam of the bridge.

9. The pivotable log saw of claim 8, further comprising a gear-driving motor driving the gear, thereby driving longitudinal displacement of the pivotable log saw along the bridge.

10. The pivotable log saw of claim 1, wherein the locking mechanism comprising a first opening in the turntable and a second opening in the frame that can be aligned with each other, and a key insertable into the first opening and the second opening when aligned.

11. The pivotable log saw of claim 10, further comprising a lever mechanism operable to move the key between an engaged position in which the key is inserted in the first opening and the second opening, and a cleared position wherein the key is removed from at least one of the first opening and the second opening.

12. The pivotable log saw of claim 11, further comprising a third opening aligned with one of the first opening and the second opening when the turntable in the maintenance position.

13. The pivotable log saw of claim 1, further comprising a wedge-locking mechanism designed to lock the turntable.

14. The pivotable log saw of claim 13, wherein the wedge-locking mechanism comprises a combination of wedging disks mounted to a shaft to which is mounted the turntable.

15. The pivotable log saw of claim 14, wherein the wedging disks comprising complementary sloped faces facing each other, wherein the combination of wedging disks are designed to expend axially upon relative rotation of a first wedging disk relative to the other one of the wedging disks.

16. The pivotable log saw of claim 15, wherein the sloped faces comprise a plurality of segmented sloped portions.

17. The pivotable log saw of claim 14, further comprising an actuator and arm assembly coupled to one of the wedging disks.

18. The pivotable log saw of claim 17, wherein the actuator is an electric jack.

19. The pivotable log saw of claim 14, further comprising securing component mounted to the shaft of the turntable, the securing component limiting axial displacement of a sprocket mounted to the shaft away from the frame, defining a maximum length over the shaft for the sprocket and the wedging disks.

20. The pivotable log saw of claim 1, further comprising a shaft-driving motor driving a motorized shaft on which is mounted the turntable.
